(19) United States
(12) Patent Application Publication
(10) Pub. No.: US 2010/0250386 A1
(43) Pub. Date: Sep. 30, 2010

(54) Method and system for personalizing online content

(76) Inventors: Chien-Hung Liu, Banciao City (TW); Chi-Chen Cheng, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,921

(22) Filed: Jul. 28, 2009

(30) Foreign Application Priority Data
Mar. 30, 2009 (TW) 98110424

(51) Int. Cl. G06F 17/30; G06Q 30/00

(52) U.S. Cl. 705/26; 707/E17.108; 707/E17.044

(57) ABSTRACT

Method and system for personalizing online content are disclosed. One of the features of the invention is to determine a user's preference based on the information of the network-based digital content downloaded by the user, and accordingly to build a personalized database. In reference with the personalized database, the system will provide the related personalized information. According to the preferred embodiment, a network connection between a user information system and a remote information service platform is established in the beginning. The method then goes to analyze the user's preference from the selected digital content, and build the personalized database. After that, the invention accordingly provides the personalized information relating the preferred video and audio content. The method is preferably adapted to an electronic commercial platform which provides personalized commercial content for further consumption activity as a specific program is used to display the commercial content on a computer screen.

### BACKGROUND OF THE INVENTION

1. Field of the Invention

The present invention relates to a method and a system for personalize online content, more particularly to establish a personalized database in reference with the characteristics under an analysis of the entertainment content, in order to provide the personalized information for further commercial activities.

2. Description of Related Art

Applications with various online services via Internet are getting widespread on the premise of network security. Consumers gradually express their will to perform the online trading and online payment. For example, people use the network mall to go shopping, conduct auction, or even transfer accounts, check balance, pay fees, buy fund, trade stocks or other similar commercial activities by online banking.

A general online commercial activity needs users actively demanding the specific merchandise based on their needs. Alternatively, some trading possibilities occur by freely browsing the web content. In the meantime, the users still consider whether it is a secure network environment or not for guaranteeing their rights and interests.

If the user can conveniently obtain the information (such as advertisement) of the specific merchandise in accordance with his preference or interest before searching or browsing the products, not only shortening the time spend but also providing greater consumption possibility.

Some prior arts disclose that a scheme provides contents based on the user content preferences. Reference is made to U.S. Patent Pub. No. 2007/0299833, which provides a network-based determination of user content preferences. It is featured that a personalized preference is made automatically according to the user actions on the network. In which, the preference data is uploaded to a server for creating a preference database for a certain network community. The data in the preference database can be a basis for creating the member information for each network community.

### SUMMARY OF THE INVENTION

In addition to establish a reference database in accordance with users' network actions, the present invention provides a method and a system for personalizing online content. Preferably the present invention is to analyze users' activities and preferences through a proprietary digital content channel, in order to establish a personalized preference database. The major way is to utilize a proprietary software tool to perform an analysis during the period of a user using the image or audio. The claimed system then extracts characteristics from the image or audio used by the user. After that, the characteristics can be used for establishing the personalized database. The content recorded in the personalized database is used for providing the corresponding personalized information to users.

One of the embodiments of the method of personalizing online content is directed to establish the personalized database in accordance with a user's preference. The entertainment contents, including audio and video, are preferably the subject used for extracting the characteristics of the digital content. The online digital entertainment contents, including video, audio, text, can be downloaded in form of streaming data or a file.

In connection with an electronic commercial platform, the personalized information made by the personalized database can be a basis for providing the convenient and personalized commercial service. Next, the user may conduct consumption on a local user-end information system.

One of the objects of the present invention is to provide a method for personalizing online content. The preferred embodiment includes a first step of initializing an online information system. The online information system provides a connection established between a user-end information system and an information service platform. Next, a plurality of digital content channels are provided for users to select through an interface made by a platform agent program. At the moment, the information service platform receives the selections made by the users, and broadcasts the streaming data according the selections, or provides the data to be downloaded. The method is to analyze the streaming data or the downloaded file, and extracts digital content characteristics therein. After that, a lookup table is introduced. A personalized database is then established based on the information of the digital contents and the corresponding characteristics in the lookup table. According to the personalized database, the personalized information can be provided consequently.

In a preferred embodiment, the system for providing the personalized online content of the present invention includes the interconnected information service platform and the user-end information system. The information service platform includes a digital content database and a personalized database for recording the digital contents and the personalized preferences respectively. Furthermore, a data mining means is used to analyze the digital contents broadcasted from the digital content database, and extract characteristics therefrom. The personalized database is then established.

A user-end information system connects to the information service platform through a platform agent program via network. This user-end information system is such as a computer system. An entertainment content playing unit in the system is used to play the streaming digital contents.

When the personalized database is established, the relevant personalized information is provided to users. Included is the service provided by the electronic commercial platform. The user-end information system further includes a chip card reader capable of online payment.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a schematic diagram of the structure of the personalized online information system of the present invention;

FIG. 2 shows another schematic diagram of the structure of the personalized online information system of the present invention;

FIG. 3 is a diagram of a user-end graphical interface of the claimed personalized system of the online information.

FIG. 4 shows a diagrammatic table used for the claimed personalized online information system;

FIG. 5 shows a flow chart of the method for personalizing online content of the present invention;

FIG. 6 show a flow chart of the method of broadcasting the personalized information by applying the personalized database of the present invention;

FIG. 7 shows a flow chart of the commercial activity in reference with the personalized information.

### DETAILED DESCRIPTION OF THE PREFERRED EMBODIMENTS

The present invention relates to a method and a system for personalizing the online contents. The online digital content majorly includes streaming video or audio, downloadable file, and other information such as image or text. Preferably, the present invention further utilizes a user-end proprietary program to analyze the digital content downloaded by a particular user, and extract the characteristics therein. A personalized database is then established accordingly. After that, the personalized information in accordance with every user can be provided based on the personalized database. In one embodiment, the personalized commercial service is provided to establish a particular connection to a specific electronic commercial platform. The user may easily obtain the preferred service from the specific platform according to his preference for further possible consumption.

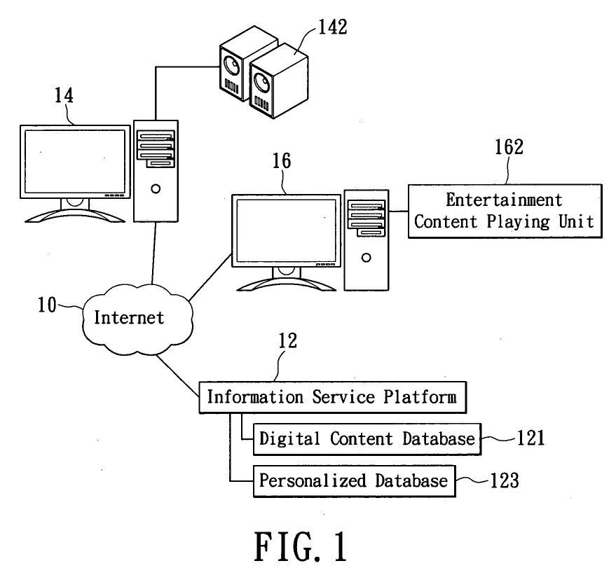

FIG. 1 shows a schematic diagram of the system for personalizing online content of the present invention. An information service platform 12 is included. The platform 12 provides various kinds of the digital contents for the remote users to download. The claimed system mainly includes the information service platform 12 and the user computers 14, 16 interconnected via network. Multiple users use the platform agent programs installed in the computers (14, 16) to link network, and to download the digital contents from the platform 12.

According to one embodiment, the user computers 14, 16 are preferably the multimedia computers. By which, it is to download streaming data via Internet 10. The shown entertainment content playing unit 162 is used to play the streaming video, and the speaker 142 installed to the user computer 14 is used to listen to the streaming music. Similarly, the other types of digital data can also be streaming downloaded. Preferably, the information service platform 12 includes a digital content database 121, in which the digital contents such as video, audio, image and text are included. The personalized database 123 having the personalized information in accordance with the user preferences is additionally included.

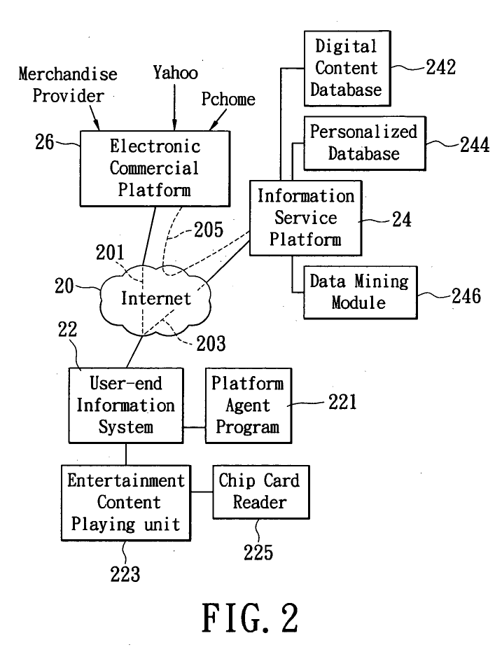

The platform agent program installed in the user computer 14, 16 is used to analyze and extract the user-preferred information, so that it can broadcast the personalized information to the users. The platform agent program includes various items regarding the digital contents. The users can select the preferred content being downloaded through a user interface provided by the program. A variety of selected digital contents are cross-analyzed to find the user preferred contents. Reference is made to FIG. 2 showing structure of the system for personalizing online contents of the present invention.

The main structure of the present invention shown in FIG. 2 has the user-end information system 22, the information service platform 24 and the electronic commercial platform 26, and they are interconnected via Internet 20. The user-end information system 22 connects to the information service platform 24 via a connection 203. The digital contents, the analyzed data, and the signals regarding the personalized data therebetween are preferably broadcasted on the connection 203. The user-end information system 22 further connects to the electronic commercial platform 26 via a connection 201. On the connection 201, the personalized commercial messages in accordance with the user preferences, including the actions of consumptions, are broadcasted. Furthermore, a secure channel is established on a connection 205 between the information service platform 24 and the electronic commercial platform 26. For example, a proprietary channel or a secure connection based on Internet 20 is preferred. The electronic commercial platform 26 itself can be a merchandise provider, or a platform integrating the various products, such as the merchandise provider shown in the figure. The commercial platform is an agency platform between the merchandise provider and the claimed information service platform 24, in order to provide the various products and the relevant information.

According to one of the embodiments, the claimed system for personalizing online contents has the information service platform 24 and the user-end information system 22. The information service platform 24 at least has a digital content database 242, a personalized database 244 and a data mining module 246.

The digital content database 242 mainly records the digital contents used to provide for the users, including video, audio, image and text. The video/audio content is preferably broadcasted by means of streaming, or downloaded as a file. The personalized database 244 is to record the personalized information after an analysis process.

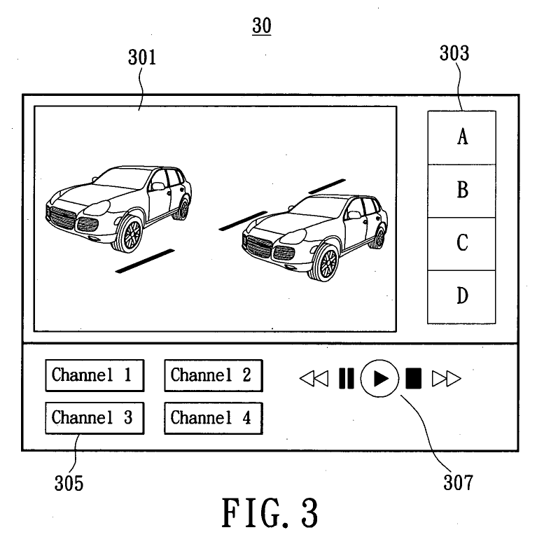

The user-end information system 22 is located at one end of the connection to Internet 20. The information service platform 24 displays various types of the digital contents through the platform agent program 221 installed in the computer. The plurality of digital content channels are displayed thereby, for an example shown in FIG. 3, the digital content channels include a plurality of types of videos and audios. The users may download the digital contents from the information service platform 24 through the program 221.

The user-end information system 22 further includes an entertainment content playing unit 223 for playing, listening, or watching every type of the digital contents. In one embodiment, the system for personalizing online contents provides a mechanism of identifying a connection source on account of the purpose of personalization. The identification mechanism is used for establishing the connection between the information service platform 24 and the user-end information system 22, so as to build the personalized database. The way to identify the connection source may use in combination of account and password, or other equivalent scheme, or to identify the network address, or use an identity code built in a specific device. Alternatively, an identity code for identification is stored in the entertainment content playing unit 223 in the computer system. Whereby the information service platform 24 identifies the connection source by means of the entertainment content playing unit 223, and not limited in any system.

For further consumption actions, the present invention further connects to the electronic commercial platform 26 and introduces the personalized characteristics in order to provide the personalized information. The personalized information preferably includes commercial advertisement, product information and the relevant shopping platform. Users can thereby use an online payment mechanism functioned by a chip card reader 225 connected with the user-end information system 22. Via the secure mechanism built in the chip card, such as credit card, banking card, or electronic wallet, which provides the similar security.

Particularly, the information service platform 24 includes a data mining scheme provided by a data mining module 246. The data mining scheme is preferably implemented by software. The data mining module 246 includes a software tool used for analyzing the digital content broadcasted from a digital content database. The software tool has a module for extracting the digital content characteristics after analyzing the content, a module for categorizing according to the extracted characteristics. A personalized database. 244 is then established.

The mentioned software tool is essentially used for analyzing the user-selected digital content broadcasted from the digital content database 242, in which the related characteristics are extracted for establishing the personalized database 244. The users can utilize a user interface generated by a platform agent program 221 to select, the digital contents to be downloaded. The platform agent program 221 is run in the user-end information system 22, preferably a multimedia computer system. In the current embodiment, the claimed system then extracts characteristics from the selected digital contents by processing a comparison through a preset lookup table. For example, the information service platform 24 firstly creates a lookup table containing the digital contents and the corresponding characteristics. Though the lookup table and the related characteristics with corresponding connection sources, the personalized database is then established.

When the data mining module 246 catches the information as a user downloading a specific digital content, the module 246 obtains the corresponding characteristics through the lookup table in this embodiment. The data mining module 246 can further extracts the actions made by the user in order to establish a precise personalized database. The lookup table for indexing is not necessarily a static table, but is a dynamic table modified in accordance the user preference.

The data mining module 246 can catch the user preference in accordance with the types of selected digital contents. Furthermore, the data mining module 246 can precisely obtain the preferred levels regarding how the user prefers the specific digital contents according to different gauges. Preferably, several thresholds can be set for gauging the preferred levels. For example, if the user selects a specific type of music, it is easily to conclude the user preference. After repeating the process of collecting the user preferences, the system can obtain more precise user preferences. In further detailed analysis, the data mining module 246 can catch the levels of user preferred digital contents based on the comparison on the basis of duration. Thereby an evaluation table is established. For example, if the user listens to a streaming music for a shorter period of time, it shows a low preferred level. If the user listens to a complete music, or repeats to play the music, it shows a high preferred level.

After repeating to analyze the user preference, a precise personalized database can be established.

FIG. 3 shows a schematic diagram of a graphic user interface for the system for personalizing online content. The diagram 330 is an exemplary example of the platform agent program installed in the user-end information system. In one preferred embodiment, the user-end information system connects to the information service platform or the electronic commercial platform through the platform agent program. By this program, the identity information showing the connection source is transmitted to the platform for identification.

After initiating the platform agent program, referring to the diagram 30, it includes a main information region 301, a personalized information region 303, a digital-content-channel selection region 305 and a play-control region 307. The platform agent program provides a plurality of digital content channels, including channel 1, channel 2, channel 3 and channel 4, for user to click and select. After making a selection, the selected video or audio is down streaming, or directly downloaded as a file to the user-end information system. Meanwhile, the information service platform processes an analysis and retrieves the digital contents. The play-control regions 307 has several control keys for controlling the progress of streaming data, including backward, pause, play, stop, fast forward keys. The digital content is displayed in the main information region 301.

After processing the above-described data mining and accumulating the information for a period of time, the personalized database with corresponding connection source is established. The information service platform the broadcasts the personalized information to the user-end information system based on the personalized database. The personalized information is displayed in the personalized information region 303. The A, B, C and D shown in the diagram depict the links to the user-preferred products or product information. After selection, the electronic commercial platform provides further commercial services.

The information service platform mainly provides remote information services through the platform agent program. The services include downloading online video, audio, image, text, and data, and moreover, product shopping, and ticket service. A user interface is provided, especially an interactive user interface. The web browser installed in a computer system is used for reading the services, or displaying the information.

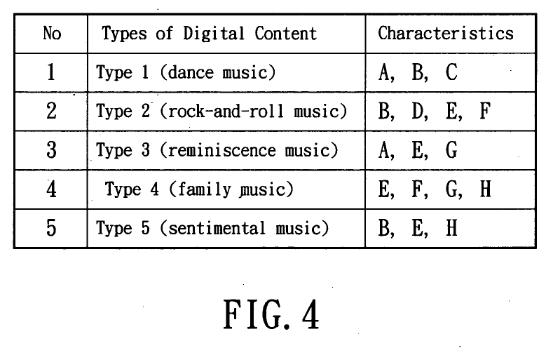

FIG. 4 shows a schematic diagram of a lookup table of the claimed system. The digital content channels provided by the platform agent program can include many types of music, such as dance music, rock-and-roll music, reminiscence music, family music, and sentimental music. After the user selects one type of music, the corresponding characteristics recorded in the lookup table can be obtained. For example, type 1 indicates the dance music, and A, B and C are the corresponding characteristics. Type 2 indicates the rock-and-roll music, and its corresponding characteristics are B, D, E and F. Type 3 indicates the reminiscence music, and its corresponding characteristics are A, E and G. The characteristics E, F, G and H correspond to the type 4, the family music. Type 5 indicates sentimental music, and the corresponding characteristics are B, E and H.

In practical implementation, the each characteristic can be divided into different detailed categories. Those characteristics can be cooperated with the preferred levels to establish a more precise personalized database.

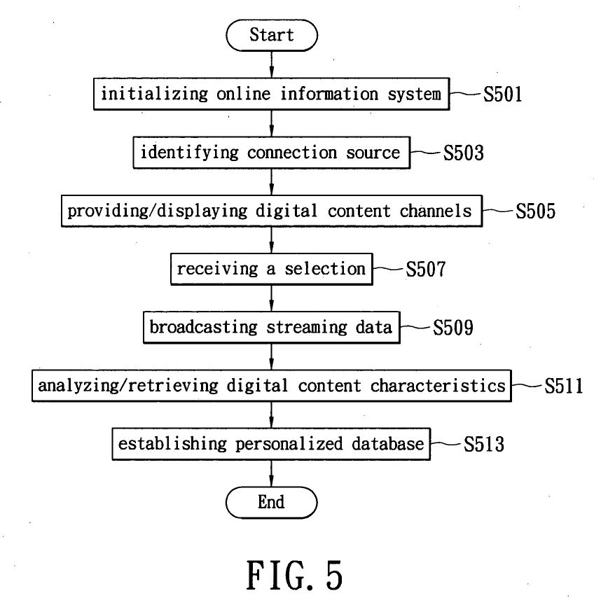

Reference is made to FIG. 5 shows a flow chart of the method for personalizing online content.

In the beginning, the step S501 shows a step of initializing an online information system. The network connection between the user-end information system and the information service platform is established firstly. Next, the information service platform identifies each connection source (step S503). The way to identify the connection sources is to determine the user-end equipment, or the like.

After identification of the connection sources, the information service platform provides the digital content channels to be displayed through the platform agent program. A plurality of optional items indicating the various types of digital content channels are generated (step S505). The optional items are provided to one or more connection sources. The users can make one or more selections of the channels, and the selection signals are generated afterwards. The information service platform then receives the selection signals (step S507). After that, the information service platform broadcasts the related streaming data in step S509. Alternatively, the information service platform provides the related files to be downloaded by the users. The each digital content channel is a specific type content, and it has its own characteristics. Through the user's actions, the characteristics with corresponding digital contents can be extracted by means of data mining (step S511). Next, the personalized database is established (step S513).

In one embodiment, the means of data mining can analyze the types, time, and use status from the digital contents since the digital contents are broadcasted by streaming. Therefore, the user preference is obtained from the accumulated data being analyzed.

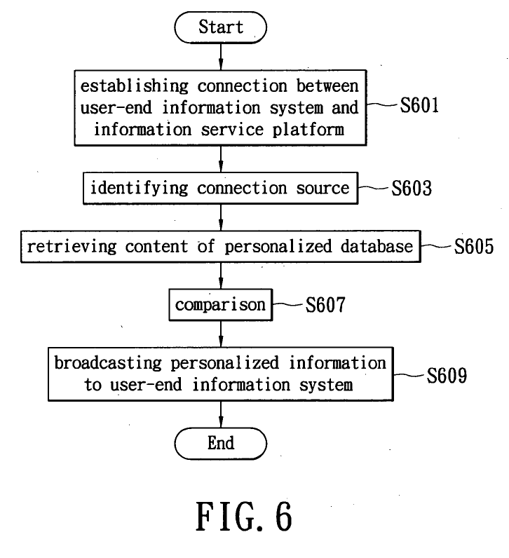

The method for personalizing the online content based on the personalized database of the present invention is shown as the flow chart of FIG. 6.

In the beginning, the connection between the user-end information system and the information service platform is firstly established (step S601). Next, the system identifies the connection source (step S603). The content of personalized database is retrieved according to the identified connection source (step S605).

The user preferences with corresponding connection source are recorded in the personalized database. Based on the personalized database, the information service platform finds out the user-preferred product, service or the relevant information by processing a comparison with the stuff in the electronic commercial platform (step S607). The information service platform then broadcasts the preferred personalized information to the user-end information system through the platform agent program according to the result of comparison (step S609).

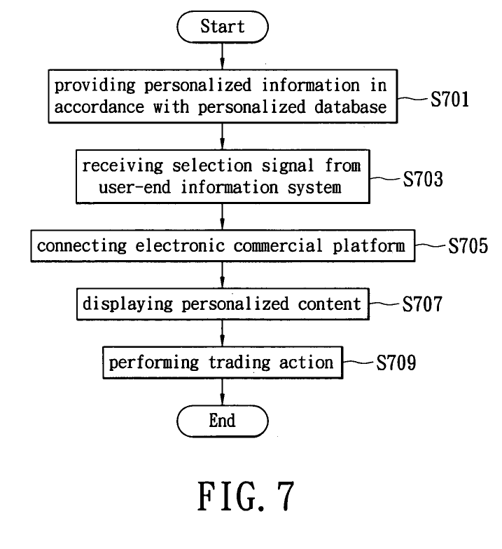

The above-described personalized information includes the personalized content of video, audio, advertisement, merchandise, and messages, or their combination. The personalized information broadcasted to the user end is definitely fit in with the user preferences. It is noted that the scheme for providing the personalized information in accordance with the user preferences can generate more effective advertisement actions. FIG. 7 shows a flow chart illustrating the further commercial activities.

The information service platform provides the personalized information in accordance with the personalized database initially (step S701). When the personalized video, audio, image or text is displayed on the user-end screen, the user selects a specific item through a user interface. Next, the related selection signals are received by the information service platform (step S703). In the meantime, the information service platform connects to the electronic commercial platform in step S705. Next, the corresponding personalized content is displayed according to the selection signals (step S707).

In practical, the personalized content would be a web page relating a specific product, or a picture relating the product. The user can perform trading actions such as to perform online payment (step S709). Over a span of analysis and a period of retrieving user preferences, the personalized information can comparatively fit in with the user's preferences. In view of commercial consideration, the personalized information can be used to provide the services of personal concern, and reduce the time to browse the merchandise.

To sum up, the method and the system for personalizing online content are firstly to establish the personalized database in accordance with the user preferred digital contents. The personalized information is then provided consequently.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A method for personalizing online content, comprising:
initializing an online information system;
providing a plurality of digital content channels having a plurality of channel selection items with various program types for one or more connection sources;
receiving one or more selected items of the digital content channels;
broadcasting streaming content with corresponding selected items;
analyzing the streaming content and extracting a plurality of characteristics from the content;
establishing a personalized database based on the characteristics; and
providing personalized information in accordance with the personalized database.

2. The method of claim 1, wherein the step of initialization further includes an earlier step of establishing a connection between a user-end information system and an information service platform.

3. The method of claim 2, wherein the plurality of digital content channels are provided for the one or more connection sources by executing a platform agent program in the user-end information system.

4. The method of claim 2, wherein the streaming content is downloaded from the information service platform by executing a platform agent program in the user-end information system.

5. The method of claim 2, wherein the information service platform performs a process of identifying the one or more connection sources after the step of initialization.

6. The method of claim 5, wherein the personalized database is established in accordance with the one or more identified connection sources.

7. The method of claim 6, wherein the personalized database records the connection sources and their corresponding characteristics of the digital contents.

8. The method of claim 1, wherein the digital content channels includes the channels with various music or video types.

9. The method of claim 8, wherein the characteristics are extracted by analyzing the music or video type downloaded by the connection source.

10. The method of claim 1, wherein the personalized information provided in accordance with the personalized database includes alone or in combination of:
personalized video or audio;
personalized advertisement;
personalized article; and
personalized new.

11. The method of claim 1, wherein the personalized database is established by means of looking up a table.

12. The method of claim 11, wherein the method of looking up the table is to compare the content in a lookup table with the extracted characteristics of digital contents.

13. A system for personalizing online content, comprising:
an information service platform having a digital content database, a personalized database and a means of data mining, wherein the means of data mining is to analyze the digital content broadcasted from the digital content database and extract characteristics in the digital content, in order to establish the personalized database; and
a user-end information system, connecting to the information service platform via a network connection through a platform agent program, and playing the digital content by a content playing unit.

14. The system of claim 13, wherein the digital content is downloaded from the digital content database to the user-end information system by a streaming means.

15. The system of claim 13, wherein a means of looking up a table and a means of identifying connection source are used to establish the personalized database in accordance with characteristics of the digital content.

16. The system of claim 13, wherein the user-end information system utilizes the platform agent program to download the digital content that displayed as a plurality of digital content channels.

17. The system of claim 16, wherein the digital content channels include the channels having a plurality of music types.

18. The system of claim 16, wherein the digital content channels include the channels having a plurality of video types.

19. The system of claim 13, wherein the personalized information provided in accordance with the personalized database includes alone or in combination of:
personalized video or audio;
personalized advertisement;
personalized article; and
personalized new.

20. The system of claim 13, wherein the system further comprising:
an electronic commercial platform, connecting to the information service platform and the user-end information system via the network connection, wherein the electronic commercial platform provides the information on digital articles to the information service platform via the network connection.

21. The system of claim 20, wherein the user-end information system further connects to a chip card reading unit which is used for a user performing a trade on the electronic commercial platform.
